(19) United States
(12) Patent Application Publication
(10) Pub. No.: US 2024/0386722 A1
(43) Pub. Date: Nov. 21, 2024

(54) DATA COLLECTING DEVICE, METHOD, AND COMPUTER PROGRAM FOR COLLECTING DATA, AND DATA COLLECTION INSTRUCTION DEVICE

(71) Applicant: Woven by Toyota, Inc., Tokyo (JP)

(72) Inventor: Masahiro TANAKA, Tokyo-to (JP)

(73) Assignee: Woven by Toyota, Inc., Tokyo (JP)

(21) Appl. No.: 18/610,412

(22) Filed: Mar. 20, 2024

(30) Foreign Application Priority Data
May 15, 2023 (JP) 2023-079942

(51) Int. Cl. G06V 20/56; G06V 10/44; G06V 10/764

(52) U.S. Cl. CPC G06V 20/56; G06V 10/44; G06V 10/764

(57) ABSTRACT

A data collecting device includes a processor configured to determine whether snow lies around a vehicle, set a type of feature to be detected, based on the result of determination of the presence or absence of the snow, detect a feature of the set type from an image representing an area around the vehicle generated by a camera mounted on the vehicle, and generate probe data representing the detected feature.

### FIELD

The present invention relates to a data collecting device, a method, and a computer program for collecting data used for generating or updating a map as well as a data collection instruction device.

### BACKGROUND

Highly precise maps to which an autonomous vehicle-driving system refers for autonomous driving control of a vehicle are required to represent information on roads accurately. Thus, data representing features on or around a road in a predetermined region, which is obtained by a sensor mounted on a vehicle that actually travels in the predetermined region, is collected from the vehicle. However, depending on weather around the vehicle, it is difficult to detect such a feature from a sensor signal. Thus, a technique to collect data by referring to weather information has been proposed (see Japanese Unexamined Patent Publication JP2008-39687A).

In a technique disclosed in JP2008-39687A, a vehicle-side device for a road map updating system successively determines whether a road being traveled by a vehicle is a new road that is not included in road map data. The vehicle-side device transmits an image of the surroundings of the vehicle captured by a vehicle-mounted camera to a map management device, based on the fact that it is determined that an image captured by the vehicle-mounted camera while the road being traveled by the vehicle is determined to be a new road can be used for updating center-side road map data, based on weather information.

### SUMMARY

In some regions, there may be snow on roads for a long period. In such a case, the above-described technique fails to collect images and to update map information, while snow remains. It is therefore desirable that feature-representing data usable for generating or updating map information can be collected even with snow on a road.

It is an object of the present invention to provide a data collecting device that can collect feature-representing data even with snow on a road.

According to an embodiment, a data collecting device is provided. The data collecting device includes a processor configured to: determine whether snow lies around a vehicle, set a type of feature to be detected, based on the result of determination of the presence or absence of the snow, detect a feature of the set type from an image representing an area around the vehicle generated by a camera mounted on the vehicle, and generate probe data representing the detected feature.

The processor of the data collecting device preferably sets a three-dimensional structure on or around a road as the type of feature to be detected, when the processor determines that snow lies around the vehicle; and sets a predetermined feature including an on-surface structure formed along the surface of a road or the ground around the road as the type of feature to be detected, when the processor determines that snow does not lie around the vehicle.

In this case, the processor preferably detects the three-dimensional structure by inputting the image into a first classifier that has been trained to detect the three-dimensional structure from the image, when the processor determines that snow lies around the vehicle; and detects the predetermined feature by inputting the image into a second classifier that has been trained to detect the predetermined feature from the image, when the processor determines that snow does not lie around the vehicle.

According to another embodiment of the present invention, a data collection instruction device is provided. The data collection instruction device includes a processor configured to: determine whether snow lies in a predetermined region, notify a collection instruction to collect probe data representing a feature of a predetermined type in the predetermined region to a snowplow via a communication device when the snow lies, and notify the collection instruction to a vehicle other than a snowplow via the communication device when the snow does not lie.

According to still another embodiment of the present invention, a method for collecting data is provided. The method includes determining whether snow lies around a vehicle; setting a type of feature to be detected, based on the result of determination of the presence or absence of the snow; detecting a feature of the set type from an image representing an area around the vehicle generated by a camera mounted on the vehicle; and generating probe data representing the detected feature.

According to yet another embodiment of the present invention, a non-transitory recording medium that stores a computer program for collecting data is provided. The computer program includes instructions causing a processor mounted on a vehicle to execute a process including determining whether snow lies around the vehicle; setting a type of feature to be detected, based on the result of determination of the presence or absence of the snow; detecting a feature of the set type from an image representing an area around the vehicle generated by a camera mounted on the vehicle; and generating probe data representing the detected feature.

The data collecting device according to the present disclosure has an advantageous effect of being able to collect feature-representing data even with snow on a road.

### BRIEF DESCRIPTION OF DRAWINGS

FIG. 1 schematically illustrates the configuration of a data collecting system equipped with a data collecting device.

FIG. 2 schematically illustrates the configuration of a vehicle.

FIG. 3 illustrates the hardware configuration of the data collecting device according to an embodiment.

FIG. 4 is a functional block diagram of a processor of the data collecting device.

FIG. 5A illustrates an example of a feature of a type to be detected when snow lies.

FIG. 5B illustrates another example of a feature of a type to be detected when snow does not lie.

FIG. 6 is an operation flowchart of a data collecting process.

FIG. 7 illustrates the hardware configuration of a server, which is an example of a data collection instruction device.

FIG. 8 is a functional block diagram of a processor of the server.

FIG. 9 is an operation flowchart of a process related to an instruction to collect data.

### DESCRIPTION OF EMBODIMENTS

A data collecting device, a method and a computer program for collecting data executed by the data collecting device, and a data collection instruction device will now be described with reference to the attached drawings. The data collecting device is mounted on a vehicle, and generates data representing a predetermined feature on or around a road (hereafter “probe data”) used for generating or updating a map, based on an image representing an area around the vehicle. To this end, the data collecting device determines whether snow lies around the vehicle, and sets a type of feature to be detected, depending on the result of the determination. In particular, when snow lies, the data collecting device sets a feature of a type that can be detected even with snow, as a feature to be detected.

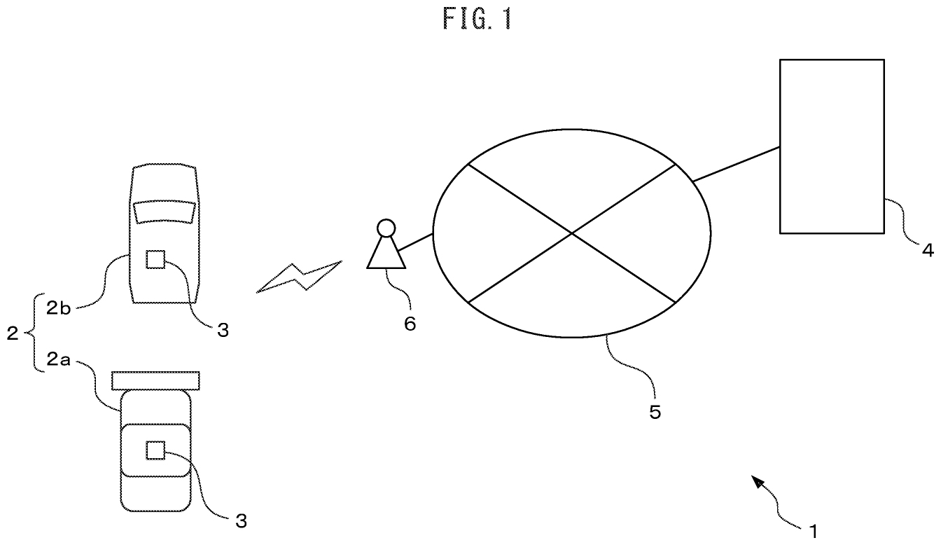

FIG. 1 schematically illustrates the configuration of a data collecting system equipped with the data collecting device. In the present embodiment, the data collecting system 1 includes a data collecting device 3 mounted on at least one vehicle 2 as well as a server 4. The at least one vehicle 2 may be a snowplow or a vehicle other than a snowplow, such as an ordinary passenger car, a bus, or a truck. The data collecting device 3 accesses a wireless base station 6, which is connected via a gateway (not illustrated) to a communication network 5 connected with the server 4, thereby connecting to the server 4 via the wireless base station 6 and the communication network 5. FIG. 1 illustrates a single snowplow 2a and a single ordinary passenger car 2b as the at least one vehicle 2, but the data collecting system 1 may include multiple snowplows each equipped with a data collecting device 3. Similarly, the data collecting system 1 may include multiple vehicles other than snowplows, the vehicles being each equipped with a data collecting device 3. When the server 4 notifies each vehicle 2 of a collection instruction uniformly regardless of the presence or absence of snow, as in a modified example described below, the data collecting system 1 may include only a snowplow or a vehicle other than a snowplow. In addition, the communication network 5 may be connected with multiple wireless base stations 6.

First, the vehicle 2 and the data collecting device 3 will be described. As described above, the data collecting system 1 may include multiple vehicles 2 each equipped with a data collecting device 3, and the vehicle 2 may be a snowplow 2a or a vehicle 2b other than a snowplow. However, the following describes a single vehicle 2 and a single data collecting device 3 because each vehicle 2 and each data collecting device 3 have the same configuration and execute the same processing in relation to a data collecting process.

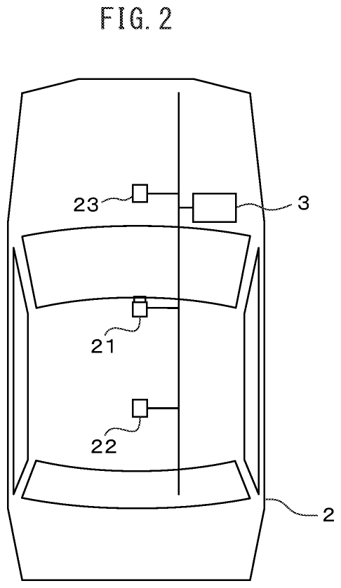

FIG. 2 schematically illustrates the configuration of the vehicle 2. The vehicle 2 includes a camera 21 for taking pictures of an area around the vehicle 2, a GPS receiver 22, and a wireless communication terminal 23, in addition to the data collecting device 3. The camera 21, the GPS receiver 22, the wireless communication terminal 23, and the data collecting device 3 are communicably connected via an in-vehicle network conforming to a standard such as a controller area network. The vehicle 2 may further include a range sensor (not illustrated) for measuring the distance to an object in an area around the vehicle 2, such as a LiDAR sensor.

The camera 21, which is an example of an image capturing unit, includes a two-dimensional detector constructed from an array of optoelectronic transducers, such as CCD or C-MOS, having sensitivity to visible light and a focusing optical system that forms an image of a target region on the two-dimensional detector. The camera 21 is mounted, for example, in the interior of the vehicle 2 so as to be oriented, for example, to the front of the vehicle 2. The camera 21 takes pictures of a region in front of the vehicle 2 every predetermined capturing period (e.g., 1/30 to 1/10 seconds), and generates images representing the region. The images obtained by the camera 21 may be color or grayscale images. The orientation of the camera 21 is not limited to the forward direction of the vehicle 2. In particular, the camera 21 of the snowplow 2a may be mounted so as to take pictures of a region behind the snowplow 2a. Then images representing a road surface from which snow is removed will be generated. In addition, the vehicle 2 may include multiple cameras 21 taking pictures in different orientations or having different focal lengths.

Every time an image is generated, the camera 21 outputs the generated image to the data collecting device 3 via the in-vehicle network.

The GPS receiver 22 receives GPS signals from GPS satellites at predetermined intervals, and determines the position of the vehicle 2, based on the received GPS signals. The GPS receiver 22 outputs positioning information indicating the result of determination of the position of the vehicle 2 based on the GPS signals to the data collecting device 3 via the in-vehicle network at predetermined intervals. Instead of the GPS receiver 22, the vehicle 2 may include a receiver conforming to another satellite positioning system. In this case, the receiver determines the position of the vehicle 2.

The wireless communication terminal 23, which is an example of a communication device, is a device to execute a wireless communication process conforming to a predetermined standard of wireless communication, and accesses, for example, the wireless base station 6 to connect to the server 4 via the wireless base station 6 and the communication network 5. In other words, a communication channel is established between the wireless communication terminal 23 and the server 4 via the wireless base station 6 and the communication network 5. The wireless communication terminal 23 receives a downlink radio signal including a collection instruction signal or a signal indicating a collection target region from the server 4, and outputs the received signal to the data collecting device 3. Further, the wireless communication terminal 23 generates an uplink radio signal including collection target data of a specified type (e.g., probe data or an image) received from the data collecting device 3. The wireless communication terminal 23 transmits the uplink radio signal to the wireless base station 6, thereby transmitting the collection target data to the server 4.

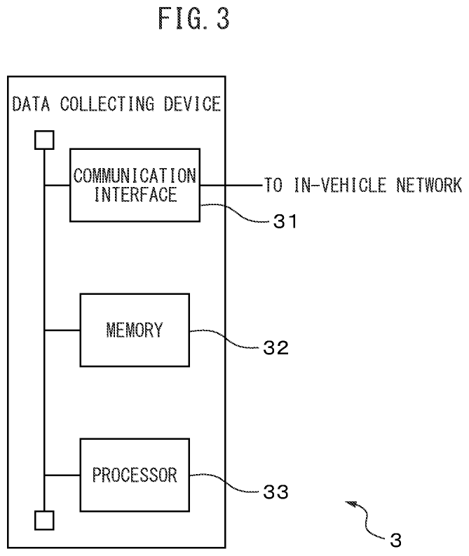

FIG. 3 illustrates the hardware configuration of the data collecting device 3. The data collecting device 3 temporarily stores images received from the camera 21. In addition, the data collecting device 3 generates probe data, based on, for example, the images, and temporarily stores the generated probe data. The data collecting device 3 transmits the probe data and the images to the server 4 via the wireless communication terminal 23. To achieve this, the data collecting device 3 includes a communication interface 31, a memory 32, and a processor 33.

The communication interface 31, which is an example of an in-vehicle communication unit, includes an interface circuit for connecting the data collecting device 3 to the in-vehicle network. In other words, the communication interface 31 is connected to the camera 21, the GPS receiver 22, and the wireless communication terminal 23 via the in-vehicle network. Every time an image is received from the camera 21, the communication interface 31 passes the received image to the processor 33. Every time positioning information is received from the GPS receiver 22, the communication interface 31 passes the received positioning information to the processor 33. Every time information from the server 4, such as a collection instruction signal, is received from the wireless communication terminal 23, the communication interface 31 passes the information to the processor 33. Further, the communication interface 31 outputs data received from the processor 33, such as collection target data, to the wireless communication terminal 23 via the in-vehicle network.

The memory 32, which is an example of a storage unit, includes, for example, volatile and nonvolatile semiconductor memories. The memory 32 may further include other storage, such as a hard disk drive. The memory 32 stores various types of data used in a process related to data collection executed by the processor 33 of the data collecting device 3. For example, the memory 32 stores identifying information of the vehicle 2 and parameters of the camera 21, such as the focal length, the orientation, and the mounted position of the camera 21. In addition, the memory 32 stores various parameters for specifying a determiner for determining the presence or absence of snow and various parameters for specifying a classifier for detecting a feature from an image received from the camera 21. The memory 32 further stores positioning information received from the GPS receiver 22 and information representing a collection target region received from the server 4. The memory 32 may further store a computer program for implementing processes executed by the processor 33.

The memory 32 includes a storage area for storing images (hereafter an “image storing area”) and a storage area for storing probe data (hereafter a “probe storing area”). Images received by the data collecting device 3 from the camera 21 are temporarily stored in the image storing area. Probe data generated by the processor 33 is temporarily stored in the probe storing area.

The processor 33 includes one or more central processing units (CPUs) and a peripheral circuit thereof. The processor 33 may further include another operating circuit, such as a logic-arithmetic unit, an arithmetic unit, or a graphics processing unit. The processor 33 executes a data collecting process during travel of the vehicle 2.

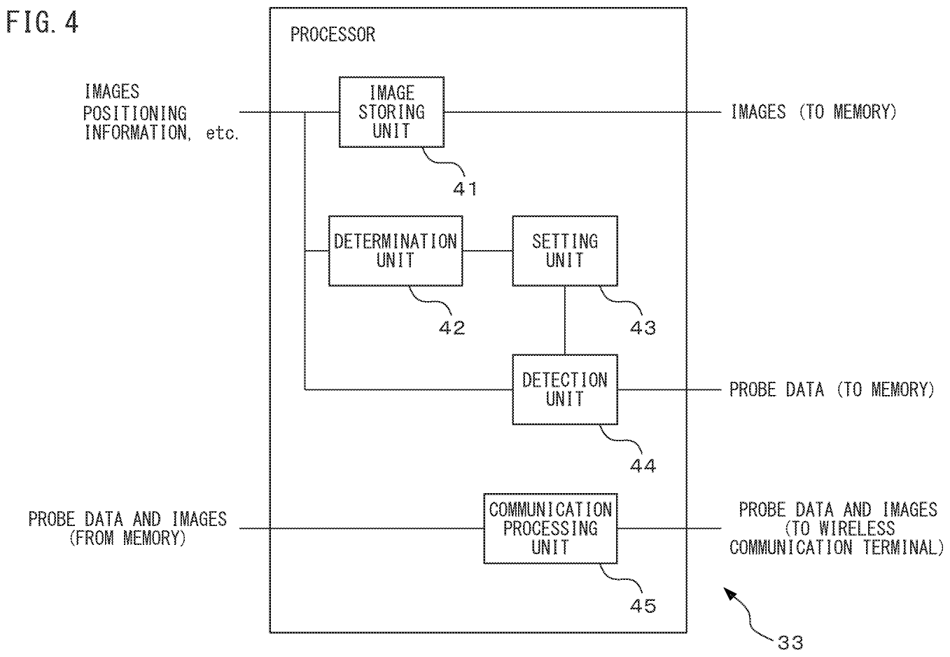

FIG. 4 is a functional block diagram of the processor 33 of the data collecting device 3. The processor 33 includes an image storing unit 41, a determination unit 42, a setting unit 43, a detection unit 44, and a communication processing unit 45. These units included in the processor 33 are functional modules, for example, implemented by a computer program executed by the processor 33, or may be dedicated operating circuits provided in the processor 33.

Every time an image is received by the data collecting device 3 from the camera 21, the image storing unit 41 writes the image in the image storing area of the memory 32. Specifically, every time an image is received from the camera 21, the image storing unit 41 associates the position of the vehicle 2 indicated by the latest positioning information and the orientation of the vehicle 2 indicated by an orientation sensor (not illustrated) with the image. The image storing unit 41 may also associate parameters of the camera 21, such as the focal length, the mounted position, and the orientation of the camera 21, with the image. The information associated with an image is uploaded to the server 4, together with the image itself, when the image is uploaded to the server 4.

The determination unit 42 determines whether snow lies around the vehicle 2. In the present embodiment, the determination unit 42 inputs the latest image received from the camera 21 into a determiner trained in advance so that a snow-covered region and the other region can be identified. When the size of a snow-covered region indicated by the result of output by the determiner is not less than a predetermined snow determination threshold, the determination unit 42 determines that snow lies around the vehicle 2. As such a determiner, the determination unit 42 can use a deep neural network (DNN) for semantic segmentation, such as Fully Convolutional Network or U-Net.

Alternatively, the determination unit 42 may determine whether snow lies around the vehicle 2, based on weather information received via the wireless communication terminal 23 from a server for distributing weather information (not illustrated). In this case, the determination unit 42 determines whether the current position of the vehicle 2 indicated by the latest positioning information received from the GPS receiver 22 is within a snowy region indicated by the weather information. When the current position of the vehicle 2 is within a snowy region, the determination unit 42 determines that snow lies around the vehicle 2.

In the following, the state where it is determined that snow lies around the vehicle 2 will be referred to simply as “snow lies,” and the state where it is determined that snow does not lie around the vehicle 2, as “snow does not lie.” The determination unit 42 notifies the setting unit 43 of the result of determination of the presence or absence of snow.

The setting unit 43 sets a type of feature to be detected, based on the result of determination of the presence or absence of snow notified by the determination unit 42. In the present embodiment, when it is determined that snow lies around the vehicle 2, the setting unit 43 sets a three-dimensional structure on or around a road as the type of feature to be detected. Examples of such a three-dimensional structure include poles or arrow signs indicating the position of a road shoulder, traffic signs, signboards, and traffic lights. This is because such a three-dimensional structure is likely to be visible without being covered with snow even if the road surface around the vehicle 2 is covered with snow. Since the surface of a traffic sign may be covered with snow, the setting unit 43 preferably sets only a traffic sign itself as a detection target, without setting information represented on the traffic sign as a detection target. Similarly, the setting unit 43 preferably detects a signboard itself rather than information represented on the signboard. The positions of traffic signs, signboards, and traffic lights are represented on a “high-precision map” or a “dynamic map” so that these positions can be used, for example, for a localization process to detect the position of a host vehicle. Examples of a three-dimensional structure to be detected may further include a snow wall formed as a result of snow removal. However, the position of a snow wall, which may vary, is preferably used for updating a dynamic map but not used for updating a high-precision map. A high-precision map is a map including information used for identifying the position of a vehicle at lane level, such as lane lines. A dynamic map is a map including, in addition to such information, semi-dynamic or semi-static information such as traffic information and dynamic information such as information on other vehicles.

When it is determined that snow does not lie around the vehicle 2, the setting unit 43 sets a predetermined feature including an on-surface structure formed along the surface of a road or the ground around the road as the type of feature to be detected. Examples of such an on-surface structure include road markings, such as lane lines, stop lines, or crosswalks, and curbstones. Examples of a predetermined feature to be detected when it is determined that snow does not lie around the vehicle 2 may include a three-dimensional structure to be detected when snow lies, such as a pole and a traffic sign.

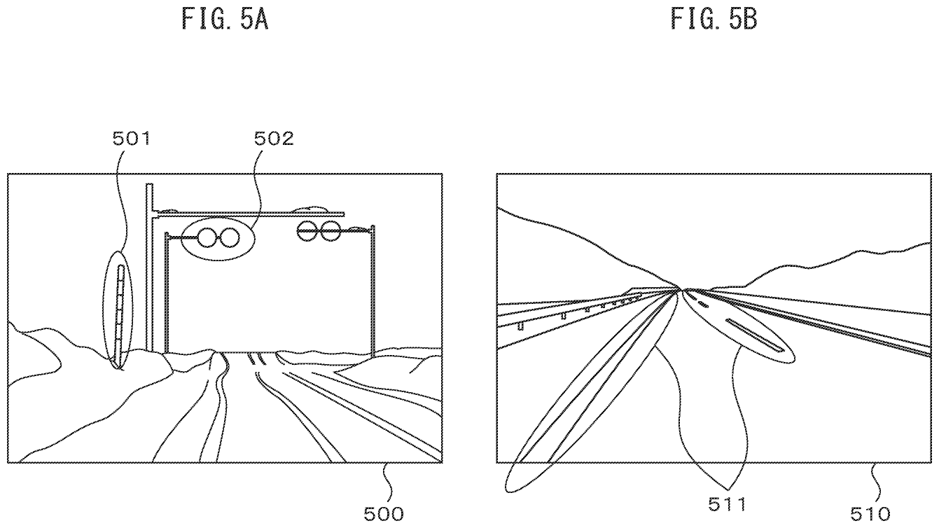

FIGS. 5A and 5B illustrate examples of a feature of a type to be detected when snow lies and when snow does not lie, respectively. In the example illustrated in FIG. 5A, snow is detected in an image 500 representing an area around the vehicle 2. Because of snow, no feature on the road surface is visible. Thus, three-dimensional structures, such as a pole 501 and traffic lights 502, are set as features to be detected.

In the example illustrated in FIG. 5B, snow is not detected, and features on the road surface are visible, in an image 510 representing an area around the vehicle 2. Thus, road markings, such as lane lines 511, are set as features to be detected.

The setting unit 43 notifies the detection unit 44 of the set type of feature to be detected.

The detection unit 44 detects a feature of the type set by the setting unit 43 from the latest image generated by the camera 21 during travel of the vehicle 2 every predetermined period or every time the vehicle 2 travels a predetermined distance. The detection unit 44 generates probe data representing the type and the position of the feature detected in the image.

For example, the detection unit 44 inputs the image into a classifier to detect a feature of the type to be detected represented in the inputted image. As such a classifier, the detection unit 44 can use a DNN having architecture of a convolutional neural network (CNN) type, such as Single Shot MultiBox Detector or Faster R-CNN. Alternatively, as such a classifier, the detection unit 44 may use a DNN having architecture of a self-attention network (SAN) type, such as Vision Transformer, or a classifier based on another machine learning technique, such as an AdaBoost classifier. Such a classifier is trained in advance with a large number of training images representing a feature of the type to be detected in accordance with a predetermined training technique, such as backpropagation, so as to detect the feature from an image. The classifier outputs information indicating a region including a feature of the type to be detected in the inputted image, e.g., a circumscribed rectangle of the feature to be detected (hereafter an “object region”) and information indicating the type of the feature represented in the object region.

In the present embodiment, a first classifier used when it is determined that snow lies around the vehicle 2 and a second classifier used when it is determined that snow does not lie around the vehicle 2 are prepared separately. More specifically, the first classifier is trained in advance so as to detect, from an image, a feature of the type to be detected when snow lies. The second classifier is trained in advance so as to detect, from an image, a feature of the type to be detected when snow does not lie. The first and second classifiers may be ones based on different architecture or the same architecture. When notified by the setting unit 43 of the type of feature for the case where it is determined that snow lies around the vehicle 2, the detection unit 44 inputs an image into the first classifier, thereby detecting a feature of the type to be detected when snow lies, from the image. When notified by the setting unit 43 of the type of feature for the case where it is determined that snow does not lie around the vehicle 2, the detection unit 44 inputs an image into the second classifier, thereby detecting a feature of the type to be detected when snow does not lie, from the image. In this way, preparation of separate classifiers for the cases where snow lies and where snow does not lie enables limitation of features of types to be detected by the individual classifiers, and thus enables the detection unit 44 to accurately detect a feature of the type to be detected.

Alternatively, a common classifier may be used when it is determined that snow lies around the vehicle 2 and when it is determined that snow does not lie around the vehicle 2. In this case, the classifier is trained in advance so as to detect, from an image, a feature of the type to be detected when snow does not lie as well as a feature of the type to be detected when snow lies. The detection unit 44 inputs an image into the classifier regardless of whether snow lies. However, when snow lies, the detection unit 44 ignores the results of detection outputted from the classifier except the result of detection of a feature of the type to be detected when snow lies. Conversely, when snow does not lie, the detection unit 44 ignores the results of detection outputted from the classifier except the result of detection of a feature of the type to be detected when snow does not lie. The use of a common classifier for the cases where snow lies and where snow does not lie enables reducing necessary hardware resources.

The detection unit 44 estimates the position of a feature represented in an object region detected from an image, based on the direction from the camera 21 to a position corresponding to the centroid of the object region, the position and the travel direction of the vehicle 2 at the time of generation of the image, and parameters of the camera 21, such as the orientation, the focal length, and the mounted position. Specifically, the detection unit 44 may estimate the position of the feature by “structure from motion (SfM).” In this case, the detection unit 44 associates object regions representing the same feature in two images obtained at different timings with each other, using optical flow. The detection unit 44 estimates the position of the feature by triangulation, based on the positions and the travel directions of the vehicle 2 at the times of acquisition of the two images, the parameters of the camera 21, and the positions of the object regions in the respective images. The detection unit 44 generates probe data including information indicating the type and the estimated position of the detected feature. In the probe data, the detection unit 44 may further include information indicating the position and the travel direction of the vehicle 2 at the time of generation of the image, and further include information indicating the size and the position in the image of the object region. The detection unit 44 generates a single piece of probe data for each detected feature. Thus, when multiple features are detected from an image, multiple pieces of probe data are generated from the image.

Every time probe data is generated, the detection unit 44 writes the generated probe data in the probe storing area of the memory 32.

The communication processing unit 45 transmits collection target data stored in the memory 32 to the server 4 via the wireless communication terminal 23.

The communication processing unit 45 determines whether the vehicle 2 has entered a collection target region, by referring to information representing the collection target region and the latest positioning information. When the vehicle 2 enters a collection target region, the communication processing unit 45 transmits collection target data of the collection target region specified in a collection instruction signal to the server 4 via the wireless communication terminal 23.

A collection target region is specified, for example, in units of one or more continuous road sections or a region of a predetermined shape. When a collection target region is specified as a road section, information representing the collection target region includes identifying information for identifying the road section and information indicating the positions of ends at which the road section can be entered or exited. When a collection target region is a region of a predetermined shape, information representing the collection target region includes information indicating the position of the outer edge of the region. The communication processing unit 45 determines that the vehicle 2 has entered a collection target region, when the position of the vehicle 2 indicated by the latest positioning information is within a region or a road section represented by the information representing the collection target region.

When probe data is specified as collection target data, the communication processing unit 45 transmits probe data stored in the probe storing area of the memory 32 to the server 4 via the wireless communication terminal 23 in chronological order.

When probe data and images are specified as collection target data, the communication processing unit 45 transmits probe data stored in the probe storing area of the memory 32 and images stored in the image storing area of the memory 32, respectively, to the server 4 via the wireless communication terminal 23 in chronological order.

An image specified as collection target data may be a sub-image. In this case, for each image stored in the image storing area, the communication processing unit 45 cuts out an area assumed to represent a road surface from the image to generate a sub-image. The communication processing unit 45 transmits probe data stored in the probe storing area of the memory 32 and the generated sub-images to the server 4 via the wireless communication terminal 23 in chronological order.

Further, the communication processing unit 45 deletes the collection target data transmitted to the server 4 via the wireless communication terminal 23 from the memory 32.

When the vehicle 2 exits a collection target region, the communication processing unit 45 identifies collection target data not yet transmitted at the time of the exit, by referring to the memory 32. When transmission of the identified collection target data to the server 4 is completed, the communication processing unit 45 finishes transmission of collection target data. The communication processing unit 45 determines whether the vehicle 2 has exited a collection target region, by referring to information representing the collection target region and the latest positioning information, similarly to determination whether the vehicle 2 has entered a collection target region.

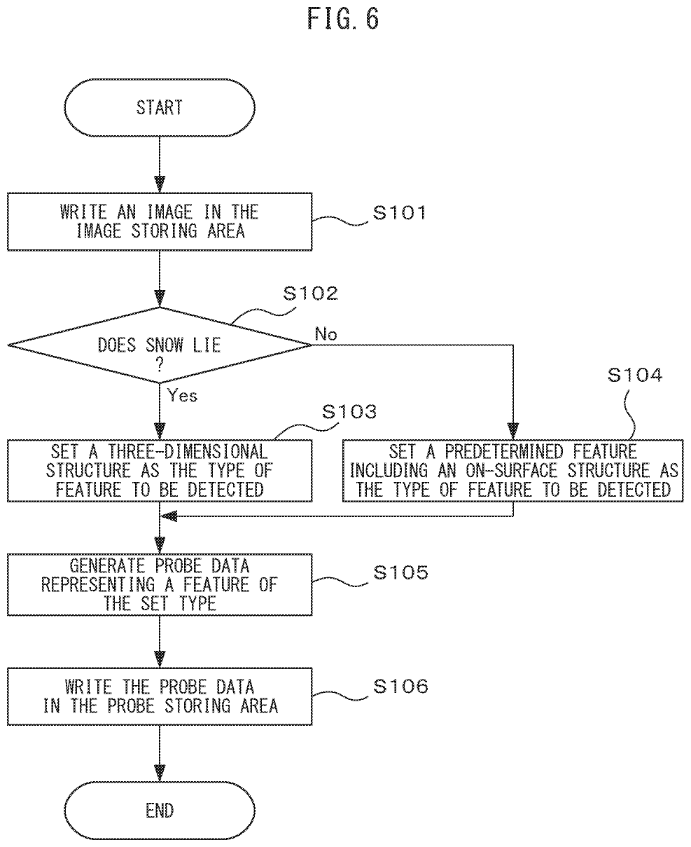

FIG. 6 is an operation flowchart of the data collecting process, in particular, a process related to generation of probe data. The processor 33 executes the data collecting process in accordance with the operation flowchart described below every predetermined period or every time the vehicle 2 travels a predetermined distance.

The image storing unit 41 of the processor 33 writes an image received by the data collecting device 3 from the camera 21 in the image storing area of the memory 32 (step S101). The determination unit 42 of the processor 33 determines whether snow lies around the vehicle 2 (step S102).

When snow lies around the vehicle 2 (Yes in step S102), the setting unit 43 of the processor 33 sets a three-dimensional structure on or around a road as the type of feature to be detected (step S103). When snow does not lie around the vehicle 2 (No in step S102), the setting unit 43 sets a predetermined feature including an on-surface structure formed along the surface of a road or the ground around the road as the type of feature to be detected (step S104).

After step S103 or S104, the detection unit 44 of the processor 33 detects a feature of the set type from an image generated by the camera 21, and generates probe data representing the detected feature (step S105). The detection unit 44 writes the generated probe data in the probe storing area of the memory 32 (step S106). The processor 33 then terminates the process related to generation of probe data.

Since it is supposed that the presence or absence of snow rarely vary locally, the processor 33 may execute the processing of steps S102 to S104 only once before or after the vehicle 2 enters a collection target region.

As has been described above, the data collecting device sets a type of feature to be detected, depending on the presence or absence of snow around the vehicle. In particular, when snow lies, the data collecting device sets a type of feature that can be detected even when the road surface is covered with snow and that is used for generating or updating a map, as the type of feature to be detected. Thus the data collecting device can collect probe data even when snow lies, and can therefore prevent collection of probe data from being stopped for a long period.

According to a modified example, the setting unit 43 may set a type of feature to be detected, for each region in an image. More specifically, in a region where the result of output from the determiner of the determination unit 42 indicates that snow lies, the setting unit 43 sets a three-dimensional structure as the type of feature to be detected, as in the above-described embodiment. In a region where the result of output from the determiner indicates that snow does not lie, the setting unit 43 sets a predetermined feature including an on-surface structure as the type of feature to be detected. For each region, the detection unit 44 then detects a feature of the type set for the region. More specifically, the detection unit 44 generates probe data of only features included in a region where it is determined that snow lies among the features detected by inputting an image into the first classifier. Similarly, the detection unit 44 generates probe data of only features included in a region where it is determined that snow does not lie among the features detected by inputting an image into the second classifier.

According to this modified example, the data collecting device can detect features appropriately even if an area where snow is removed and an area where snow is not removed coexist around the vehicle.

The following describes the server 4. The server 4 is an example of the data collection instruction device, and selects a type of vehicle to be instructed to collect collection target data, depending on the presence or absence of snow. In addition, the server 4 specifies the type of data to be collected for a collection target region, and notifies a vehicle of the selected type of a collection instruction signal indicating an instruction to collect collection target data of the specified type. In addition, the server 4 stores probe data or images transmitted from the data collecting devices 3 mounted on the respective vehicles 2 notified of a collection instruction signal. Based on the probe data or the images, the server 4 generates or updates a map of the collection target region. In addition, the server 4 notifies the individual vehicles 2 of a collection target region.

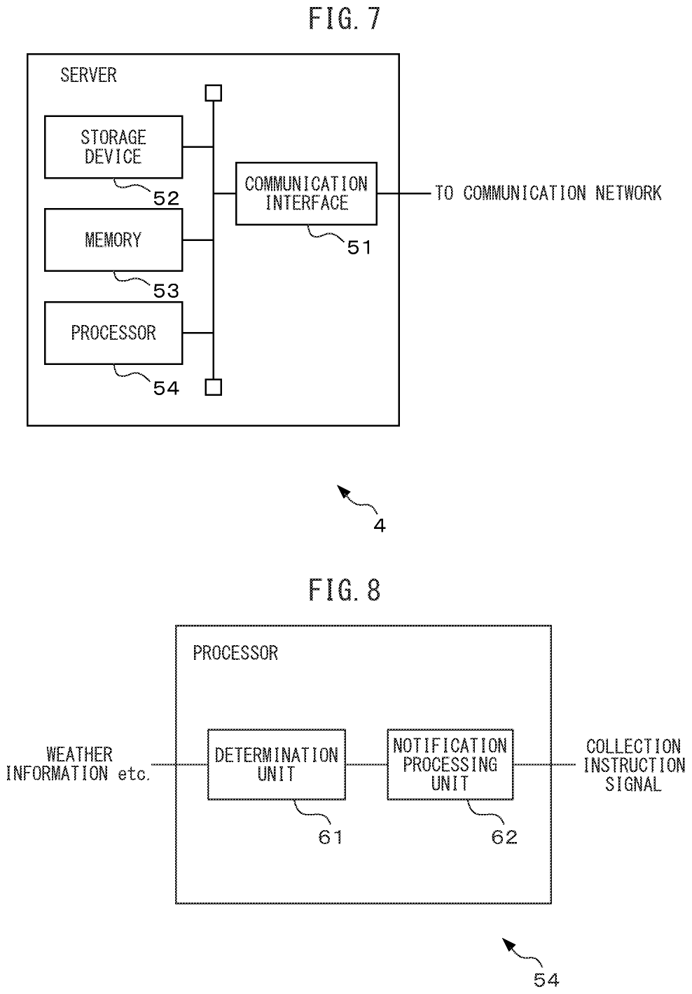

FIG. 7 illustrates the hardware configuration of the server 4. The server 4 includes a communication interface 51, a storage device 52, a memory 53, and a processor 54. The communication interface 51, the storage device 52, and the memory 53 are connected to the processor 54 via a signal line. The server 4 may further include an input device, such as a keyboard and a mouse, and a display device, such as a liquid crystal display.

The communication interface 51, which is an example of the communication unit, includes an interface circuit for connecting the server 4 to the communication network 5. The communication interface 51 is configured to be communicable with the data collecting devices 3 mounted on the respective vehicles 2, via the communication network 5 and the wireless base station 6. More specifically, the communication interface 51 passes, to the processor 54, collection target data and other data received from the data collecting devices 3 of the respective vehicles 2 via the wireless base station 6 and the communication network 5. The communication interface 51 transmits a collection instruction signal received from the processor 54 and other signals to the data collecting devices 3 of the respective vehicles 2 via the communication network 5 and the wireless base station 6.

The storage device 52, which is an example of a storage unit, includes, for example, a hard disk drive, or an optical medium and an access device therefor. The storage device 52 stores type-specifying information, collection target data collected for each of road sections, and other data. For each vehicle 2, the storage device 52 further stores vehicle type information indicating the type of the vehicle (a snowplow or another type of vehicle) and identifying information. The storage device 52 may further store a computer program executed by the processor 54 for executing a data collecting process on the server 4 side, and a map to be generated or updated based on collection target data.

The memory 53, which is another example of a storage unit, includes, for example, nonvolatile and volatile semiconductor memories. The memory 53 temporarily stores various types of data generated during execution of the data collecting process, and various types of data obtained by communication with the individual vehicles 2, such as probe data and images.

The processor 54, which is an example of a control unit, includes one or more central processing units (CPUs) and a peripheral circuit thereof. The processor 54 may further include another operating circuit, such as a logic-arithmetic unit or an arithmetic unit. The processor 54 executes the data collecting process on the server 4 side.

FIG. 8 is a functional block diagram of the processor 54 of the server 4. The processor 54 includes a determination unit 61 and a notification processing unit 62. These units included in the processor 54 are functional modules, for example, implemented by a computer program executed by the processor 54, or may be dedicated operating circuits provided in the processor 54.

The determination unit 61 determines whether snow lies in a collection target region. For example, the determination unit 61 determines whether snow lies in a collection target region, based on weather information received via the communication interface 51 from a server for distributing weather information (not illustrated). To achieve this, the determination unit 61 compares the collection target region with a snowy region indicated by the weather information. When at least a predetermined percentage of the collection target region is within a snowy region indicated by the weather information, the determination unit 61 determines that snow lies in the collection target region. Alternatively, when a reference point that is set in the collection target region (e.g., the center or centroid of the collection target region) is within a snowy region indicated by the weather information, the determination unit 61 may determine that snow lies in the collection target region.

When an image generated in the collection target region is received by the server 4 from a vehicle 2 in a most recent predetermined period (e.g., several hours to one day), the determination unit 61 may determine the presence or absence of snow, based on the image. In this case, the determination unit 61 determines the presence or absence of snow, based on the result of determination obtained by inputting the image into a determiner for determining the presence or absence of snow, similarly to the determination unit 42 of the data collecting device 3. When it is determined that snow lies, based on the image, the determination unit 61 determines that snow lies in the collection target region.

The determination unit 61 notifies the notification processing unit 62 of the result of determination of the presence or absence of snow in the collection target region.

The notification processing unit 62 selects a type of vehicle to be notified of a collection instruction, based on the result of determination of the presence or absence of snow in the collection target region. More specifically, when snow lies in the collection target region, the notification processing unit 62 selects a snowplow as the type of vehicle to be notified of a collection instruction. When snow does not lie in the collection target region, the notification processing unit 62 selects a vehicle other than a snowplow as the type of vehicle to be notified of a collection instruction. The notification processing unit 62 identifies a vehicle of the selected type among the vehicles 2 by referring to the vehicle type information and the identifying information.

The notification processing unit 62 refers to type-specifying information corresponding to the collection target region. Based on the type-specifying information, the notification processing unit 62 identifies the type of collection target data specified for the collection target region. Examples of the type of collection target data include an image representing environment around the vehicle 2 generated by the camera 21 mounted on the vehicle 2, a sub-image representing a road surface cut out from the image, and probe data representing a feature detected from the image. Thus, for each collection target region, the type-specifying information indicates an image, a sub-image, or probe data, as the type of collection target data.

The notification processing unit 62 includes information for specifying the identified type of collection target data in a collection instruction signal. When the type-specifying information indicates probe data, the notification processing unit 62 specifies only probe data as collection target data. When the type-specifying information indicates an image, the notification processing unit 62 specifies probe data and images as collection target data. When the type-specifying information indicates a sub-image, the notification processing unit 62 specifies probe data and sub-images as collection target data.

The notification processing unit 62 transmits the generated collection instruction signal to the individual vehicles 2 of the selected type via the communication interface 51, the communication network 5, and the wireless base station 6.

When multiple collection target regions are set, the processor 54 executes the processing of the determination unit 61 and the notification processing unit 62 for each collection target region.

The processor 54 may set a collection target region, based on the numbers of pieces of probe data collected for individual road sections stored in the storage device 52. For example, the processor 54 sets a road section where the number of pieces of probe data collected in a most recent predetermined period (e.g., several weeks to several months) is less than a predetermined collection threshold, as a collection target region. Alternatively, of individual road sections represented in a map to be updated, the processor 54 may set a road section such that the time elapsed since the last update is not less than a predetermined elapsed time threshold, as a collection target region. The processor 54 then notifies the set collection target region to the data collecting devices 3 of the respective vehicles 2 via the communication interface 51.

In addition, the processor 54 may generate or update a map, using the collected probe data and images. The map to be generated or updated is a map used for autonomous driving control of a vehicle, and may be a high-precision map or a dynamic map. The processor 54 executes registration between features represented in pieces of probe data collected for a continuous section by a single vehicle 2 and corresponding features represented in previously collected probe data or in the map to be updated. Of the features represented in pieces of probe data collected for the continuous section, the processor 54 identifies one that does not have a corresponding feature in the previously collected probe data or the map to be updated, as a newly installed feature. The processor 54 adds information on the identified feature (position and type) to the map to be generated or updated. Further, of the features represented in the map to be updated, the processor 54 may identify one that does not have a corresponding feature among the features represented in pieces of probe data collected for the continuous section, as a removed one. The processor 54 may delete information on the feature identified as a removed one, from the map to be updated.

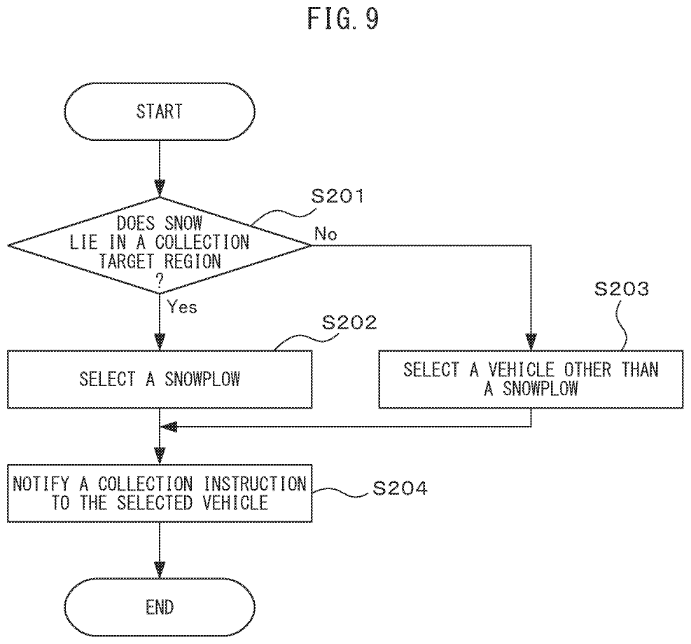

FIG. 9 is an operation flowchart of a process related to an instruction to collect data. The processor 54 of the server 4 executes the process related to an instruction to collect data, in accordance with the operation flowchart described below at predetermined timing (e.g., at a predetermined date and time).

The determination unit 61 of the processor 54 determines whether snow lies in a collection target region (step S201). When snow lies in the collection target region (Yes in step S201), the notification processing unit 62 of the processor 54 selects a snowplow as the type of vehicle to be notified of a collection instruction (step S202). When snow does not lie in the collection target region (No in step S201), the notification processing unit 62 selects a vehicle other than a snowplow as the type of vehicle to be notified of a collection instruction (step S203).

After step S202 or S203, the notification processing unit 62 notifies a collection instruction signal to the selected vehicle via the communication interface 51, the communication network 5, and the wireless base station 6 (step S204). The processor 54 then terminates the process related to an instruction to collect data.

As has been described above, the data collection instruction device selects a type of vehicle to be instructed to collect collection target data including probe data, depending on the presence or absence of snow in a collection target region. In particular, when snow lies in the collection target region, the data collection instruction device selects a snowplow as a vehicle to be instructed to collect collection target data. Thus, even when snow lies, the data collection instruction device can cause probe data to be generated and collected while a road surface is visible to a certain extent. Thus, even when snow lies, the data collection instruction device can prevent a decrease in the accuracy of a feature represented in probe data and cause the data collecting device to collect probe data of a feature drawn on a road surface, such as a road marking. When snow does not lie, the data collection instruction device causes a vehicle other than a snowplow, which does not travel often except during snow removal, to generate and collect probe data, and thus can collect probe data appropriately even when snow does not lie.

According to a modified example, the server 4 may notify each vehicle 2 of a collection instruction uniformly regardless of the presence or absence of snow in the collection target region. When the server 4 specifies a vehicle to be instructed to collect data, as described above, the processing of the determination unit 42 and the setting unit 43 may be omitted, assuming that the data collecting device mounted on each vehicle collects probe data representing a feature of the type to be collected when snow does not lie.

As described above, those skilled in the art may make various modifications according to embodiments within the scope of the present invention.

What is claimed is:

1. A data collecting device comprising:
a processor configured to:
determine whether snow lies around a vehicle,
set a type of feature to be detected, based on the result of determination of the presence or absence of the snow,
detect a feature of the set type from an image representing an area around the vehicle generated by a camera mounted on the vehicle, and
generate probe data representing the detected feature.

2. The data collecting device according to claim 1, wherein the processor
sets a three-dimensional structure on or around a road as the type of feature to be detected, when the processor determines that snow lies around the vehicle, and
sets a predetermined feature including an on-surface structure formed along the surface of a road or the ground around the road as the type of feature to be detected, when the processor determines that snow does not lie around the vehicle.

3. The data collecting device according to claim 2, wherein the processor
detects the three-dimensional structure by inputting the image into a first classifier that has been trained to detect the three-dimensional structure from the image, when the processor determines that snow lies around the vehicle, and
detects the predetermined feature by inputting the image into a second classifier that has been trained to detect the predetermined feature from the image, when the processor determines that snow does not lie around the vehicle.

4. A data collection instruction device comprising:
a processor configured to:
determine whether snow lies in a predetermined region,
notify a collection instruction to collect probe data representing a feature of a predetermined type in the predetermined region to a snowplow via a communication device when the snow lies, and
notify the collection instruction to a vehicle other than a snowplow via the communication device when the snow does not lie.

5. A method for collecting data, comprising:
determining whether snow lies around a vehicle;
setting a type of feature to be detected, based on the result of determination of the presence or absence of the snow;
detecting a feature of the set type from an image representing an area around the vehicle generated by a camera mounted on the vehicle; and
generating probe data representing the detected feature.
